(19) United States
(12) Patent Application Publication
(10) Pub. No.: US 2024/0265442 A1
(43) Pub. Date: Aug. 8, 2024

(54) BLOCKCHAIN ORACLE FOR MANAGING LOANS COLLATERALIZED BY DIGITAL ASSETS

(71) Applicant: SALT BLOCKCHAIN INC., Denver, CO (US)

(72) Inventors: Gregory Lloyd Bell, Denver, CO (US); Matthew Hill, Centennial, CO (US); Shawn Owen, Westminster, CO (US)

(21) Appl. No.: 18/473,171

(22) Filed: Sep. 22, 2023

Related U.S. Application Data
(63) Continuation of application No. 16/163,444, filed on Oct. 17, 2018, now abandoned.
(60) Provisional application No. 62/573,656, filed on Oct. 17, 2017.
(60) Provisional application No. 62/589,942, filed on Nov. 22, 2017.

(51) Int. Cl. G06Q 40/03; H04L 9/00; H04L 9/06; H04L 9/08; H04L 9/32

(52) U.S. Cl. CPC G06Q 40/03; H04L 9/0637; H04L 9/0643; H04L 9/0825; H04L 9/3239; H04L 9/50; H04L 2209/56

(57) ABSTRACT

A blockchain oracle manages loans collateralized by a digital asset. Lenders and borrowers agree to loan terms that include digital asset collateral held in a multisig wallet for which various parties hold private keys. If collateral requirements are not met by the loan such as when a Loan-to-Value ratio satisfies a margin call condition, the oracle may transmit warnings to loan participants and may initiate liquidation of the digital asset collateral to remove the margin call condition. The oracle may exist on a blockchain initialized with loan agreement information. The oracle may determine whether margin call and liquidation conditions are satisfied by updating an internal state by obtaining and/or receiving information regarding the status of the loan, the digital asset collateral, and liquidation locations on-chain, by receiving status transactions, and/or by requesting the information directly.

### CROSS-REFERENCE TO RELATED APPLICATIONS

This application claims priority benefit to U.S. Provisional Patent Application Nos. 62/573,656 filed Oct. 17, 2017 and 62/589,942 filed Nov. 22, 2017, the entire contents of each of which are herein incorporated by reference.

### BACKGROUND OF THE INVENTION

Loans may be secured by capital put up as collateral by a borrower according to a loan agreement with a lender. If collateral conditions of the loan agreement are not met, a borrower may recapitalize the collateral, pay down the loan, or the lender may sell collateral. Management of the collateral presents difficulties due to need for monitoring constantly changing information including asset value and loan status, and difficulty transacting the collateral among trusted entities.

### SUMMARY OF THE DISCLOSURE

This summary is provided to introduce a selection of concepts in a simplified form that are further described in the Detailed Descriptions. This summary is not intended to identify key features or essential features of the claimed subject matter, nor is it intended to be used to limit the scope of the claimed subject matter.

With a blockchain oracle for managing loans collateralized by a digital assets, loans may be made without resort to a credit rating system, which often inaccurately represents the credit worthiness of individuals and is rife with hazards relating to the privacy and identity security of participants, particularly of the borrowers. A blockchain oracle for managing loans collateralized by digital assets allows borrowers to participate in lending activities without revealing personal information about themselves to the lenders or to credit rating agencies that has a high potential for abuse. Due to the ease of use, security, liquidity, ease of transferability, ease of storability, ease of verification based on cryptographic proof, and other features of digital assets, lenders can collateralize loans such that losses due to bad loans are reduced and profitability improved compared to a credit rating-based lending system. In some implementations, lenders may choose to rely on a combination of credit scores of a borrower from a credit rating agency in combination with digital asset collateral requirements in the system.

A blockchain provides a trustless environment wherein a borrower may verify that loan collateral has not been moved or spent by checking a digital asset collateral wallet address on a copy of the blockchain's shared ledger. In contrast, in loans that are not collateralized by digital assets held in a public ledger wallet (e.g., precious metals or stock certificates held by the lender, etc.), a borrower may have no way of knowing if the borrower's asset has been loaned out to another entity, sold, or no longer in actual possession of the lender etc. In some implementations, the digital asset collateral wallet is a multisig wallet that requires multiple signatures by holders of private cryptographic keys including the blockchain oracle. The digital asset collateral is therefore more secure and less likely to be the subject of a theft than collateral that may be unilaterally spent or stolen from a single entity. A borrower need not worry that trust in an entity who performs servicing functions of the loan will be breached by the entity's failure to perform (e.g., escrow entity, third party money transmitters, banks, etc.). Trust in such entities is not needed because collateral wallet operations (e.g., deposit, withdraw, liquidate, etc.) may be performed by the oracle and the other loan participants, which operate within the trusted system.

Lenders also benefit from the trustless environment of the blockchain oracle for managing digital asset collateralized loans because they can check that collateral is still available from the collateral wallet. Originators of loans based on traditional collateral assets (e.g., real estate, vehicle, etc.) do not have a similar assurance of the condition and market price of the collateral asset. For example, a lender may not realize that a loan secured by a vehicle has a poor Loan-to-Value (LTV) ratio because the lender does not know the condition of the vehicle and therefore the vehicle's likely market price if it were repossessed and sold. If digital asset collateral is held in a multisig wallet for which the lender knows the funds can be moved according to oracle code executing on a blockchain, then the lender preserve an LTV that is acceptable to the lender throughout the life of the loan.

Implementations disclosed herein include a method of managing a digital asset collateral wallet including receiving loan agreement terms agreed to by a lender and a borrower, the loan agreement terms including repayment terms for a loan collateralized by a digital asset, broadcasting an oracle initialization transaction to a blockchain network having a set of consensus rules, the oracle initialization transaction including the loan agreement terms and further including oracle code executable on the blockchain network, receiving a status update to a status of the loan, broadcasting one or more status transactions to the blockchain network, the status transactions including oracle update data.

### BRIEF DESCRIPTION OF THE SEVERAL VIEWS OF THE DRAWINGS

FIG. 1 is a diagram of an example system with a blockchain oracle for managing loans collateralized by a digital asset.

FIG. 2 is a diagram of an example system for generating a multisig digital asset collateral wallet for use with a blockchain oracle for managing digital asset-backed loans.

FIG. 3 is a diagram of an example system for broadcasting blockchain oracle transactions to a blockchain for managing digital asset-collateralized loans.

FIG. 4 is a diagram of an example system with a blockchain oracle for monitoring the status of a loan collateralized by a digital asset.

FIG. 5 is a diagram of an example system with a blockchain oracle performing loan monitoring operations and wallet operations on a blockchain wallet containing digital asset collateral.

FIG. 6 is a signal diagram of an example system with a blockchain oracle performing loan monitoring operations and wallet operations on a wallet containing digital asset collateral.

FIG. 7 is a plot of outstanding loan balance and digital asset collateral value against time for a loan collateralized by a digital asset and managed by a blockchain oracle including a liquidation of collateral.

FIG. 8 illustrates example operations for monitoring a loan and performing wallet operations on a digital asset collateral wallet by a blockchain oracle.

FIG. 9 illustrates example operations for managing a loan collateralized by a digital asset.

FIG. 10 illustrates an example system that may be helpful in using the digital asset collateral wallet.

FIG. 11 illustrates example operations for a blockchain oracle managing a loan collateralized by a digital asset.

### DETAILED DESCRIPTIONS

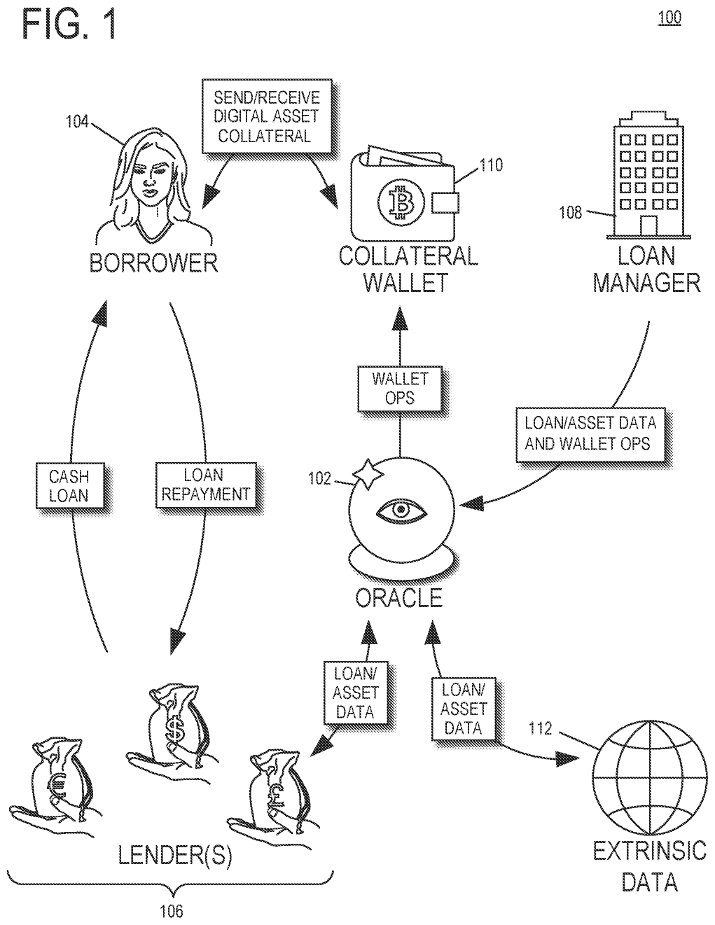

FIG. 1 is a diagram of an example system 100 with a blockchain oracle 102 for managing loans collateralized by a digital asset stored in collateral wallet 110. The digital asset collateral wallet 110 holds one or more digital assets as collateral on a loan between one or more lenders 106 and a borrower 104. The system 100 includes various components for managing the digital asset collateralized loan including a blockchain oracle 102 and/or a loan manager 108. The blockchain oracle serves as an autonomous immutable loan management software that can receive, integrate, and act upon loan information extrinsic to the blockchain.

The lender(s) 106 and the borrower 104 form a loan agreement for a loan (e.g., a loan) with loan agreement terms (e.g., interest rate, repayment schedule, collateralization rate, currency, etc.). The loan includes collateralization terms according to which a digital asset is held as collateral in the collateral wallet 110 while the loan is outstanding. The collateralization terms may include various parameters that govern how the digital asset collateral is held during the course of a loan repayment period (e.g., a collateralization rate, a minimum collateralization level, a Loan-to-Value ratio (LTV), one or more types of digital assets, a formula for determining prices of digital assets, a formula for determining liquidity of digital assets, etc.). The borrower 104 and the lender 106 may make aspects of the loan agreement terms and/or loan payment and repayment activity available to other parts of the system 100 for managing the digital asset collateral as described herein.

One type of collateralization term for a digital asset-backed loan is the method of calculation of a minimum LTV based on a liquidity value of the digital asset collateral. An LTV provides a level of protection against risk of loss for the lender because the collateral may be sold in the event of a borrower default. A liquid collateral asset is more easily sold than an illiquid asset and therefore provides better protection, even when comparing two collateral wallets that have the same nominal value. The size of the loan is also a factor in determining a minimum LTV value. If a loan is large and collateralized by an illiquid asset, then the lender may not be able to convert enough of the collateral to another currency (e.g., from a thinly traded digital asset to U.S. dollars) fast enough to cover its loss in the case of a borrower default. In such a case of illiquid collateral, the lender may insist on a higher LTV than what would be agreed to in the case of a more liquid collateral asset. Since liquidity values of a collateral digital asset can change over time (e.g., if an asset is de-listed from one or more public exchanges during the course of loan repayment), in some implementations the blockchain oracle can receive a status update transaction to modify the LTV values that would trigger a margin call, margin warning, etc.

Digital assets used for collateral may be any type of digital asset that can be held in a blockchain wallet address (also referred to herein as a payment address) and managed by entities including the blockchain oracle. The digital assets may include cryptocurrency coins or tokens that are used by network participants as a type of money. The digital assets may also include tokens that are transferable and represent ownership of real-world assets such as a title registry for property. Other types of digital assets include tokens that represent an ownership share in an entity, a right to receive payment from an entity (e.g., the token holder receives coupon payments promised on a bond). and/or tokens that are redeemable for a good or service. Yet other types of digital tokens that may be used as collateral include tokens that have value based on the immutable nature of a blockchain (e.g., identity tokens, proof-of-prior publication, proof-of-citizenship, etc.).

Digital asset collateral includes digital assets that may be transferred between parties and monitored as described herein (e.g., cryptocurrencies, tokens transferable on a blockchain network according to smart contract rules, entries on a distributed ledger for which a party holds a private key, etc.). In one implementation, the digital asset collateral is stored in a collateral wallet 110. The digital asset collateral wallet 110 may be monitored by the participants in the system 100 (e.g., by exploring a public blockchain, by gaining access to a permissioned ledger, etc.). The digital asset collateral wallet may include a wallet address (e.g., a public cryptographic key) to which funds may be sent on a blockchain network by broadcasting a transaction to the blockchain network. In some implementations, the digital asset collateral wallet 110 is a multisignature (multisig) wallet for which various participants in the system 100 hold a single private key, and spending funds from the digital asset collateral wallet 110 requires a minimum number of private keys to sign a transaction (e.g., 3-of-4 multisig).

The lender(s) 106 and the borrower 104 may agree on loan terms by communicating directly or via a lending marketplace. At a lending marketplace, lenders may advertise loan terms to borrowers who may choose to apply for a loan. A loan application may include demonstration of possession of digital asset collateral funds (e.g., cryptographically signing a message with a private key to prove ownership of an amount of digital assets). In some implementations, loan applications may include information needed to obtain a credit rating of the borrower 104 from a credit rating agency and/or other information relating to the borrower's financial status (bank statement, deed of ownership, etc.). Lenders may offer loans of national fiat currencies issued by nations or states (e.g., U.S. Dollar, Euro, Japanese Yen, etc.) or other digital assets.

In some implementations, a loan manager 108 (also referred to as a loan incubator) performs operations of the system 100. A loan manager 108 may, for example, operate a loan marketplace at which lenders 106 may advertise loans to borrowers 104 and borrowers 104 may provide information relating to identity, ability to pay, proof of digital asset reserves, etc. The loan manager 108 (or other participants in the system 100) may deploy a blockchain oracle 102 to perform some of the loan management and digital asset collateral wallet operations disclosed herein. In one implementation, the blockchain oracle 102 is established by the loan manager 108 on a blockchain by broadcasting a transaction to the blockchain network including executable code for the oracle 102 (e.g., a smart contract on the Ethereum blockchain). The oracle 102 may be modified by additional transactions that are broadcast to the blockchain network subsequent to the transaction that initialized the oracle 102. Oracle code may be modified by additional transactions, additional transactions may be broadcast to the blockchain relating to the oracle 102. On some blockchain implementations, on-chain code may not execute unless the code receives a transaction (e.g., a zero ether transaction on the ethereum blockchain). As such, another party such as the loan manager 108, an entity communicating with the oracle 102 over the communications network 112, and/or another participant may send to the oracle 102 a heartbeat transaction, a transaction bearing new data, and/or a transaction requesting that the oracle 102 obtain new data regarding the loan. These transactions may cause the oracle 102 to “wake up” to perform requested functions and/or other functions according to the oracle code on the blockchain.

The blockchain oracle 102 may receive information regarding status of the loan between the borrower 104 and the lenders 106 (e.g., whether the loan is in good standing, payment history of the loan, amortization schedule, whether origination payment from the lenders 106 has been made, etc.). The oracle 102 may receive information from outside sources, such as over communications network 112 (e.g., the Internet) or directly from other participants in the loan network illustrated in the example of FIG. 1. In implementations, the oracle 102 can be viewed as having an internal state representing the status of one or more loans. The oracle 102 may not be active in the sense that it will make updates to the internal state of its own accord. Instead, the oracle 102 receives a transaction from one of the other participants (e.g., borrower 104, loan manager 108, lenders 106, from extrinsic data source 112, etc.) to update the internal state of a loan. In some case, the transaction received by the oracle 102 must include gas or a transaction fee sufficient to support execution of the oracle code on the blockchain to make the state update and to perform any actions (e.g., operations on the collateral wallet 110, requests for outside services to make margin warnings, etc.). Any participant with access to a copy of the blockchain on which the oracle 102 executes may monitor the internal state of the oracle 102 to receive notice of internal state changes regarding any digital asset-backed loans of interest (e.g., the borrower 104 may monitor her own loan to confirm the loan is in good standing according to the oracle 102, that the LTV ratio of the loan is not in danger of triggering a margin call, whether deposits/withdrawals on the collateral wallet 110 have been recognized by the oracle 102, etc.).

One source of potential state updates to the blockchain oracle 102 is illustrated in FIG. 1 as extrinsic data 112. Extrinsic data 112 can be data that originates from sources other than the participants illustrated in FIG. 1. For example, one or more digital asset exchanges may supply data regarding the digital assets held in the collateral wallet 110 being traded on their exchange (e.g., price, volume, liquidity, etc.) that can be used by the oracle 102 to perform wallet operations on the collateral wallet 110 and/or perform other internal status updates. Other examples of extrinsic data 112 include parties who are paid by one of the participants to supply data regarding the loan such as accountants, auditors, banking service providers, government agencies, etc. In some implementations, participants such as the borrower 104 and/or lenders 106 may pay gas costs to the oracle 102 that can be used to confirm extrinsic data transactions such that public or free sources of extrinsic data 112 can be used to update the internal state of the oracle 102 without the sources of extrinsic data 112 incurring a cost.

Before origination of a loan from the lenders 106 to the borrower 104, the loan agreement terms may include a collateral amount of a digital asset deposited in the collateral wallet 110. Depending on the loan agreement terms, the amount of digital assets to be deposited in the collateral wallet 110 may be based on a percentage of the loan, referred to herein as the loan's LTV. The collateral wallet 110 may hold a single type of digital asset or may include multiple types of digital assets. For blockchains based on an unspent transaction output (UTXO) model, each different type of digital asset may have a unique wallet with a payment address on the respective blockchains of the digital assets held as collateral. On blockchains with account-based systems, digital assets that circulate on the blockchain may be held in the same account as one another (e.g., ERC-20/EIP-20 tokens on the ethereum blockchain). If an address or addresses of the digital asset collateral wallet 110 is provided to the lenders 106 before origination of the loan, the lenders 106 may monitor the address on a blockchain to see when the digital asset collateral has been deposited. Once the digital asset collateral has been deposited in the wallet 110, the participants of the system 100 may broadcast wallet operations to the wallet and/or to one another to move some or all of the digital asset collateral (e.g., return collateral to the borrower once the loan repayment is complete, liquidate collateral if the loan is no longer in good standing or if the value of the collateral falls below a threshold as determined by the terms of the loan agreement between the borrower 104 and the lenders 106).

The current computer infrastructure for managing a loan transaction and the collateral put up for that transaction typically includes a server that stores a database of data associated with the loan. The database can store a copy of the loan agreement, data regarding the amount of the loan, the payoff amount, the payment history, data about the parties to the transaction and so forth. When data about the loan agreement changes, such as a change in an asset value is identified, then a user needs to manually access the database for that loan and make changes to the database. The parties to the loan also must trust the entity managing the database that the proper data will be entered.

There are problems with the existing computer infrastructure for managing loans. First, entities like credit rating systems may not have rankings that accurately rate the credit worthiness of a borrower. Next, the parties to the transaction must trust the entity managing the loan as that entity owns the server that stores the database and data for managing the loan process. Privacy and security are also problems associated with the current system.

The present disclosure provides an improvement in computer technology by implementing several new technical features associated with a loan transaction. The technical improvements include the implementation of such components as a blockchain oracle deployer that can broadcast a blockchain oracle initialization transaction to a blockchain network. The blockchain oracle initialization transaction can include the details of the loan agreement terms and include data about a digital asset that represents collateral for the loan. The blockchain oracle initialization transaction also can include oracle code executable on the blockchain network for managing, via a blockchain-based smart contract, the life of the loan.

While loan transactions are generally known, the present disclosure implements a novel and new technical approach to address some of the problems in the existing loan computer infrastructure. The introduction of these components represents a non-conventional combination of features that, when combined as disclosed herein, improve the functioning of computer systems with respect to loan management and also introduce the concept of blockchain based management of loan transactions and digital assets for representing collateral.

Another new component in the system disclosed herein is the blockchain oracle updater that is configured to transmit update transactions to the blockchain oracle. The new computer components enable a trustless loan management process and include additional benefits not realized by the traditional loan management approach. It is noted that the concepts disclosed herein do not represent merely the implementation of a fundamental economic practice that long has been prevalent in our system of commerce. The use of the blockchain oracle, the deployer, and the oracle updater, and their functionality in connection with a blockchain network, are non-conventional improvements to the prior computer systems used to manage loans.

In addition, it is noted that rather than implementing a basic fundamental economic practice on a computer system, the present disclosure requires and improves the use of computers as tools for achieving additional benefits for loan management. For example, the use of the oracle deployer, the blockchain network, and the oracle updater, provide a new set of tools and functionality for managing a loan collateralized by a digital asset and that eliminates the trust requirement found in traditional loan transactions.

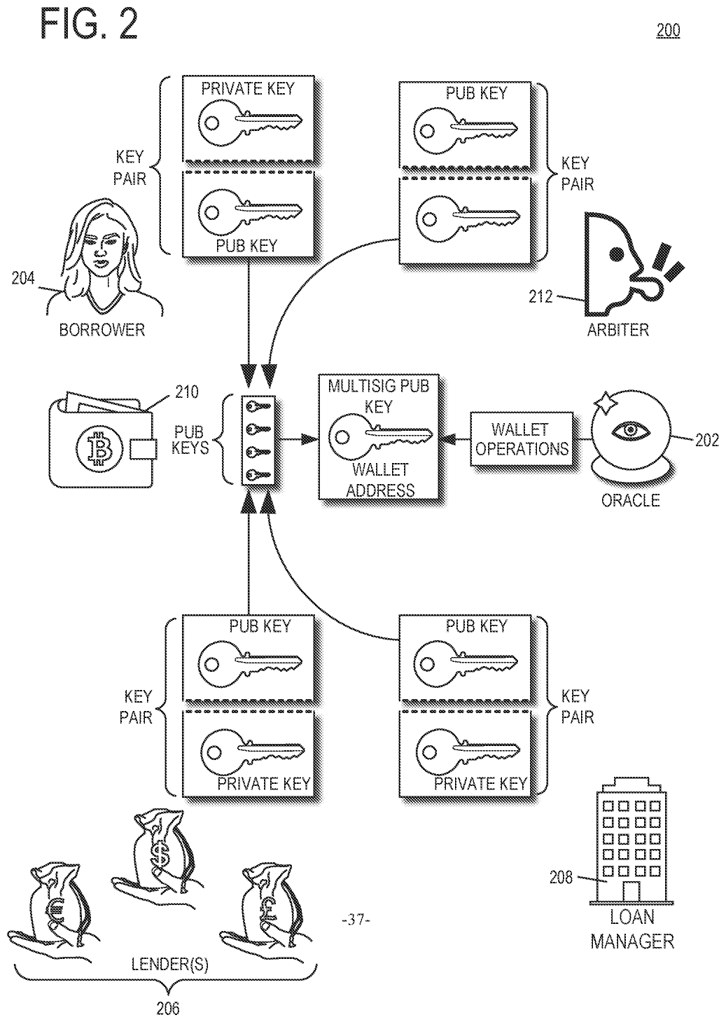

FIG. 2 is a diagram of an example system 200 for generating multisig keys with a blockchain oracle 202 for managing a digital asset collateral wallet 210. In the example illustrated in FIG. 2, there are four parties in the system 200 in addition to the oracle 202: the borrower 204, the lenders 206, an arbiter 212, and a loan manager 208. Each of these four parties generates a public/private key pair in a secret process. The parties will generate unique public and private keys if they can produce a sufficient amount of entropy in the key generation process. The private keys are therefore known only to the respective entities that created them. In other implementations, the example system 200 includes more than or fewer than four signing parties.

After the parties in the system 200 have generated their keys, a multisig public key can be generated from the four public keys. Each party may communicate the party's public key to any or all of the other parties in the system 200 until at least one party has all four public keys. The four public keys are inputs to create the multisig address that will serve as the digital asset collateral wallet 210. A party that calculates the multisig public key address may communicate the address to the other parties. Alternatively, or additionally, each party may calculate the public multisig key address if it has received the public keys of each of the other parties in the system 200.

The borrower 204 broadcasts a transaction to the multisig address on a blockchain network to transfer the digital asset collateral to the wallet 210. If the blockchain is a public blockchain or if the parties in the system 200 have permissioned access to the blockchain, they can verify that the digital asset collateral has been deposited in the wallet 210 by checking a copy of the shared ledger after the borrower's transaction has been confirmed according to the consensus rules of the blockchain. Parties can verify collateral wallet 210 contents by maintaining their own copy of the shared ledger, by requesting the balance of the wallet 210 from another blockchain network node, etc.

In the example illustrated in FIG. 2, the digital asset collateral wallet 210 is a 3-of-4 multisig wallet. A 3-of-4 multisig means that a minimum of three of the four private keys must sign a transaction to successfully move funds out of the collateral wallet 210. Participants in the system 200 may sign a transaction and transmit the signed transaction to other participants, who can also sign the transaction. Once at least three of the participants has signed the transaction with their respective private keys, then the transaction may be broadcast to the blockchain network to move funds out of the collateral wallet 210. For example, if repayment of a loan is complete, the digital asset collateral is released back to the borrower under the terms of the loan agreement by broadcasting a signed transaction to the blockchain network to transfer the digital asset collateral from the collateral wallet 210 to a wallet address controlled by the buyer 204 (e.g., to a non-multisig wallet address for which the borrower 204 holds the private key).

Digital asset collateral may be moved from the collateral asset wallet 210 for other reasons as well. Depending on the terms of the loan agreement, the borrower may be responsible for maintaining a minimum digital asset collateral value or responsible not to exceed a maximum LTV on the loan. If the LTV of the loan, on the other hand, is not near a maximum LTV, then the terms of the loan agreement may allow the borrower 204 to withdraw some of the digital asset collateral from the wallet 210 to her own wallet. If the value of the digital asset collateral increases over a period of time during which the borrower 204 has paid down a principal balance on the loan, then the LTV may improve to the point where it substantially exceeds the minimum LTV under the terms of the loan agreement. In such a case, the borrower 204 may request that the other participants in the loan system 100 sign a transaction moving some of the digital asset collateral to another wallet owned by the borrower 204. The borrower 204 may construct a transaction with the borrower's wallet as an output and sign the transaction. The transaction may then be sent to other system participants with a request to sign.

Another reason the digital asset collateral may be moved from the collateral wallet 210 is if the LTV exceeds a level determined by the loan agreement or if the borrower misses one or more repayments on the loan and the loan is no longer in good standing. The terms of the loan agreement may provide for liquidation of some or all of the digital asset collateral if the LTV exceeds an agreed limit or if a number of repayments are missed by the borrower. Some or all of the digital assets stored on the collateral wallet 210 may be moved to a digital asset exchange where they may be sold for another type of currency or another digital asset (e.g., the digital assets may be sold for the currency that was loaned to the borrower 204 under the terms of the loan agreement), to any party willing to buy the digital assets, and/or transferred to the lender.

The borrower 204 may refuse to sign a transaction with the borrower's private key to the digital asset collateral wallet 210 if the funds are to be liquidated. Since, in the example illustrated in FIG. 2, the digital asset collateral wallet 210 is a 3-of-4 multisig wallet, the other three participants in the system 100 must sign a transaction with their respective private keys to move digital asset collateral out of the wallet 210. These participants, the arbiter 212 and the loan manager 208, may have access to the status of the loan between the lenders 206 and the borrower 204 and are therefore able to determine when the loan is not in good standing. In another implementation, the arbiter 212 and the loan manager 208 receive a copy of the loan repayment schedule and the loan agreement terms relating to minimum collateralization, maximum LTV and/or other parameters of the loan relating to the collateral. The loan manager 208 and the arbiter 212 may independently and/or cooperatively receive one or more price feeds of the digital assets in the collateral wallet 210 to determine whether the terms of the loan agreement permit moving digital asset capital out of the wallet 210.

The loan manager 208 and the arbiter 212 may further determine which addresses are appropriate to receive any funds moved from the collateral wallet 210. For example, if a maximum LTV is breached under the terms of the loan agreement due to falling digital asset collateral prices, then the terms of the loan agreement may permit funds to be moved to a digital asset exchange for liquidation. The digital asset exchange may be an approved destination for funds under the loan agreement, and the oracle 202 and/or the loan manager 208 may choose to sign a transaction with their private keys moving digital asset collateral from the wallet 210 to a wallet controlled by the digital asset exchange and under the control of one of the participants in the system 100.

In the example illustrated in FIG. 2, actions described as having been taken by the participants in the system 200 (e.g., the borrower 204, the arbiter 212, the lenders 206, the loan manager 208) include status update transactions transmitted to the blockchain oracle 202 and confirmed on a blockchain of the oracle 202. In this sense, the blockchain oracle 202 can be viewed as having taken the action based on the information supplied by the participant (e.g., updating a minimum LTV level of a loan based on new liquidity data regarding digital asset collateral held in the collateral wallet 210 supplied by the arbiter 212). In some implementations, the blockchain oracle 202 may determine that an update window of time has elapsed since the blockchain oracle 202 has received a status update transaction from a participant and the internal state of the blockchain oracle 202 regarding a digital asset-backed loan is therefore “stale.” The update window of time may be included as one of the loan terms of the digital asset-backed loan. If the blockchain oracle 202 has deemed its internal status of a loan to be stale, the blockchain oracle 202 may “lock” wallet operations on the loan until such time it receives a fresh status update. The update window may be calculated with reference to a number of confirmed blocks on a blockchain of the blockchain oracle 202, an elapsed time measured in timestamps, etc.

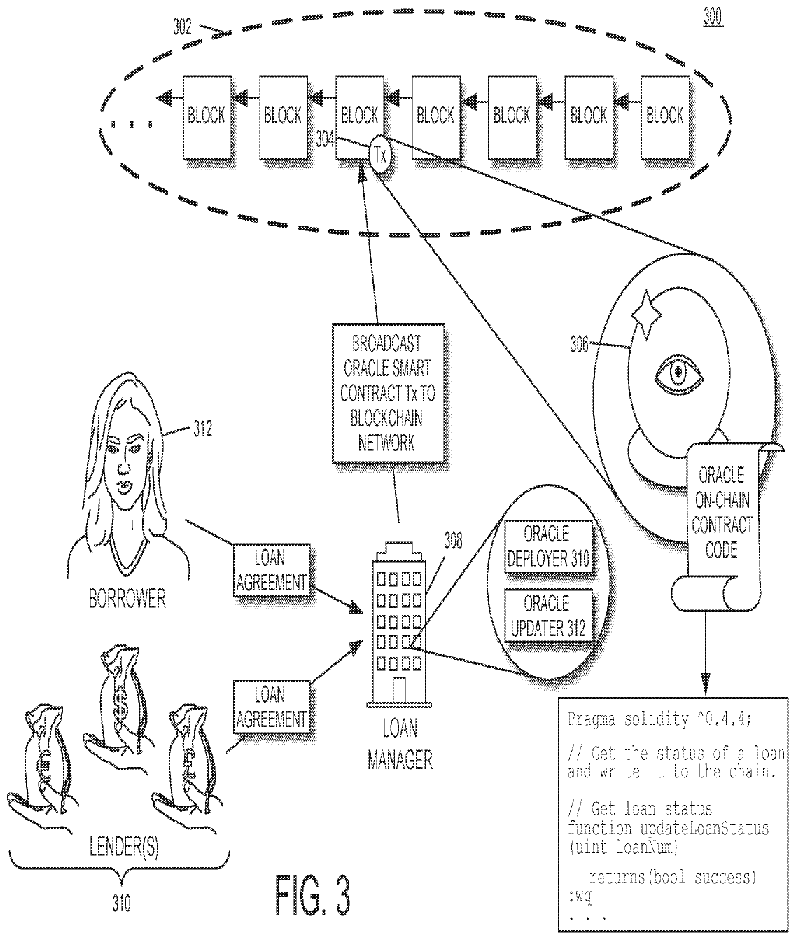

FIG. 3 is a diagram of an example system 300 for broadcasting an oracle transaction 304 (e.g., an oracle initialization transaction, a status update transaction, etc.) to a blockchain 302 for initializing and/or updating the internal state of a blockchain oracle 306 managing a loan collateralized by a digital asset. In the example illustrated in FIG. 3, a loan manager 308 received loan agreement terms agreed to by the lenders 310 and the borrower 312. Once the loan manager 308 has the agreed terms of the loan, the loan manager 308 broadcasts a transaction to the blockchain network 302 including on-chain executable code for the oracle (e.g., a smart contract on the ethereum blockchain).

In the example illustrated in FIG. 3, the blockchain 302 operates according to consensus rules applied by computers that have joined the blockchain network. The blockchain 302 is composed of blocks that are added to the chain by miners or validators. The consensus rules of the blockchain 302 may include a proof-of-work mechanism by which miners compete to find a cryptographic nonce that satisfies a difficulty target set based on the total hash power of the network. Alternatively, or additionally, the consensus rules of the blockchain 302 may include a proof-of-stake under which validators confirm transactions. In the example illustrated in FIG. 3, the network nodes of the blockchain 302 will execute code thereon and the output of the code in part of the consensus reached by the blockchain network (e.g., all executing nodes must agree on the output of on-chain code).

In some blockchains that support executable on-chain code, such as blockchain 302, the on-chain smart contract code is dormant until a status transaction “pokes” the smart contract. As such, a status transaction may be sent to the oracle 306 to periodically “wake up” the oracle and/or request that the oracle 306 perform certain functions relating to the maintenance of the loan collateralized by digital assets. A status update transaction may be sent by any system participant or there may be a whitelist of only certain participants who are authorized to send a status transaction to the oracle 306. For example, the smart contract code of the oracle 306 may include a whitelist of ethereum network addresses that are authorized to call functions on the smart contract or to send status transactions to the oracle 306. Any transactions from ethereum addresses not on the whitelist may be rejected by the oracle 306. Additionally, the oracle 306 may be modified by subsequent transactions sent to the blockchain 302 that may modify behavior of the oracle 306.

The loan manager 308 may include components for operation of the system 300 including an oracle deployer 310 and an oracle updater 312. The oracle deployer 310 is a component that broadcasts transactions to the blockchain 302 including an initialization transaction to establish the oracle 306. The oracle deployer may receive the loan agreement from the borrower 312 and lenders 310 directly or from the blockchain 302 if the other parties have stored the loan terms there. Another components of the loan manager 308 is the oracle updater 312 for transmitting update transactions to the oracle 306 such as loan update transactions and/or transactions to prod the oracle into action via methods of the on-chain contract code.

In one implementation, the following pseudo-code is a non-limiting example of an algorithm for forming transactions to broadcast to the blockchain 302.

### Transaction Generator(Loan, Deposits)=>returns Transaction

Component responsible for (1) generating a single [crypto] Transaction that will (when adequately signed) deposit the needed asset quantity to each exchange or OTC provider, (2) signing the transaction, (3) saving transaction it to local database.

| 1. | Create Transaction | |
|---|---|---|
| | a. | For each deposit in Deposits array |

| | |
|---|---|
| i. | neededBTC = exchange.sellQuantity + |
| | exchange.totalFee |
| ii. | Encumber output (value = neededBTC) to |
| | PubKeyHash of exchange.depositAddress |

| | |
|---|---|
| b. | Calculate sumOutputs = sum of output values |
| c. | Calculate generousFee = fee based on estimated transaction |
| | size and market rate / byte |
| d. | Final Output (change) |

| | |
|---|---|
| i. | Value = Loan.collateralBalance − sumOutputs − |
| | generousFee |
| ii. | scriptSig = encumbered back to same P2SH multisig |
| | script |

| | e. | Create Input(s), referencing all UTXO encumbered by current |
|---|---|---|
| | | P2SH multisig script |
| 2. | Sign Transaction (could be its own component) | |
| | a. | Retrieve as many signatures as we can |
| | b. | If (3 signatures) |

| | |
|---|---|
| i. | Signed = true |
| ii. | Execute Transaction Broadcaster |

| | |
|---|---|
| c. | If (2 signatures) |

| | |
|---|---|
| i. | Signed = false |
| ii. | “Monitor” for additional signatures |

| | |
|---|---|
| 3. | Save Transaction to database = {status: new/unconfirmed, signed: |
| | true/false} |
| 4. | Return Transaction |

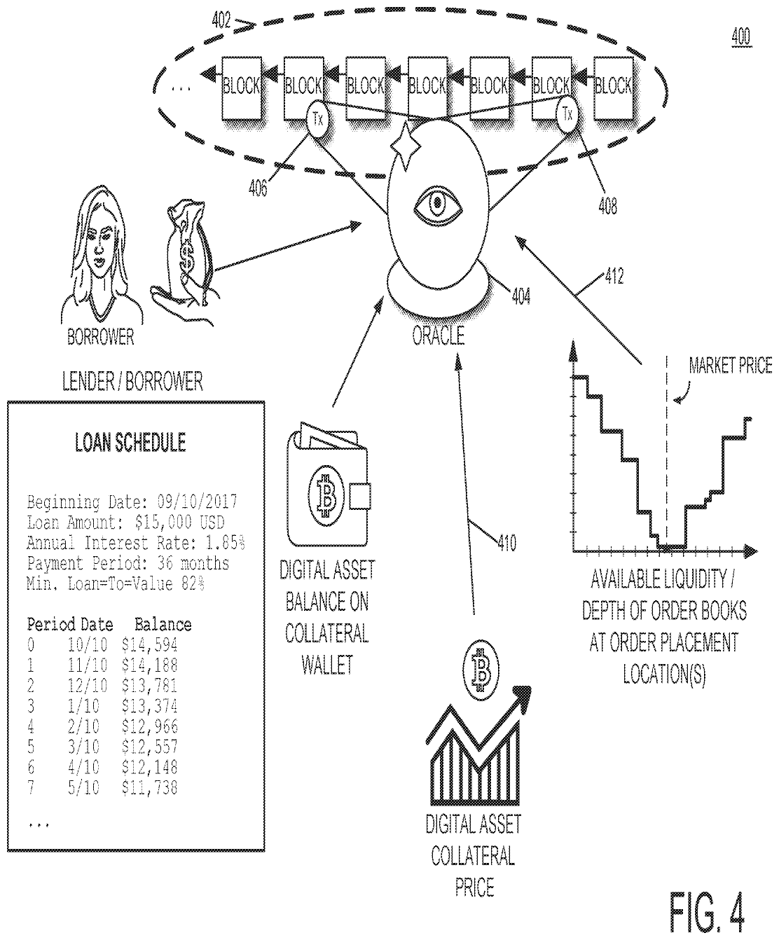

FIG. 4 is a diagram of an example system 400 with a blockchain oracle 404 for monitoring the status of a loan collateralized by a digital asset. The oracle 404 is established on the blockchain 402 by an initialization transaction 406 and may be modified by additional transactions such as transaction 408. Additional transactions may alter a state of an oracle smart contract deployed to the blockchain 402 by the initialization transaction 406.

The oracle 404 may read information from a variety of sources to perform operations for managing a loan collateralized by a digital asset in the system 400. In one implementation, the initialization transaction 406 includes loan terms agreed to by the lender and borrower. The oracle 404 therefore can determine whether the loan complies with the loan terms at various points of time over the course of the loan. The lender and/or borrower may transmit updates to the oracle 404 over the course of a loan to demonstrate the state of the loan. For example, when a borrower makes loan repayments, the borrower may transmit proof of payment to the oracle 404. In other implementations, a banking institution may provide a feed to the oracle 404 regarding the status of the loan and a history of origination and repayments on the loan.

For information to be passed to the oracle 404, data (e.g., state data) must be included in the blockchain 402 according to the consensus rules of the chain. The data may therefore be included in a transaction and broadcast to one or more participants in the blockchain network (e.g., network nodes, mining nodes, etc.). If the network of the blockchain 402 is a peer-to-peer network, then a transaction received by a first participant may be transmitted to other participants to which the first participant is connected. A transaction that is in the hands of one network participant therefore propagates around the network of the blockchain 402 until all the participants are in possession of the transaction. A participant in the system 400 therefore needs only to transmit a transaction to one blockchain network participant of the blockchain 402 for the transaction to be included in the chain and the state data sent to the oracle 404. A participant in the network 400 may transmit a transaction to at least one blockchain network participant directly or indirectly (e.g., via an application executing on a handheld device, according to biographical identity data, through an online portal with access to the blockchain network, etc.).

Another source of information that can be fed into the oracle 404 is from the digital asset collateral wallet. The oracle 404 may read the collateral balance on the wallet in different ways. If the collateral wallet is on the same blockchain 402 as the oracle, then any nodes executing oracle code will also have a copy of the shared ledger of the blockchain 402 showing the history of all transactions on that chain. The code of the oracle 404 can therefore check the balance of the collateral wallet. In other implementations, the digital asset collateral wallet exists on a different blockchain than the blockchain 402 on which the oracle 404 resides. If the collateral wallet resides on a different chain from the oracle 404, then the oracle can receive a response to a balance query from a computer that stores a copy of the ledger of that chain.

Another source of information that can be fed into the oracle 404 is a price 410 of the digital assets held as collateral on the loan. The oracle 404 may receive price information from a variety of exchange locations where trades are occurring between the type of digital asset held as collateral and other currencies or digital assets. Market trades usually occur at a regular basis on exchanges that support trading of digital assets. A market trade price feed may be received by the oracle 404 at regular intervals such that the oracle 404 can calculate a value of the collateral wallet in terms of a different currency (e.g., the currency of the loan between the lender and the borrower). In some implementations, digital asset price information may be processed by another party (e.g., the loan manager) before feeding the price information to the oracle 404. For example, a loan manager may apply a volume-weighted average to a price of a digital asset as trades across each of a group of digital asset exchanges. Alternatively, or additionally, the loan manager may exclude trading prices from exchanges that have low volume or low liquidity. In other implementations, the oracle 404 may receive raw market trade data from the exchange and may perform processing on the price data on-chain.

Another source of information that can be fed into the oracle 404 is the available liquidity and depth of order books 412 at order placement locations. Order placement locations are location where the digital asset collateral could be sold for another currency or digital asset in the event that such a sale is permitted under the terms of a loan agreement between the borrower and lender. In one implementation, the following pseudo-code in a non-limiting example of an algorithm for determining available liquidity and depth of order books:

| 1. | Push each orderBook into an orderBooks array = [{exchange, fee, | |
|---|---|---|
| | orderBook)] and arrange by fee (low to high) | |
| 2. | For each Array | |
| | a. | Splice( ) all Orders where orderBook.order.bid > sellPrice |
| 3. | Reduce( ) to find the sum = availableQuantity of the remaining | |
| | Orders: | |
| | a. | If (availableQuantity > sellQuantity) |

| | |
|---|---|
| i. | For each exchange in orderBooks array |

| | |
|---|---|
| 1. | POST to generate new depositAddress |
| 2. | Create exchangeDeposit = {Loan.id, |
| | status = unconfirmed, exchangeName, |
| | sellPrice, depositAddress, sellQuantity = 0, |
| | totalFee = 0} |

| | |
|---|---|
| ii. | While sellQuantity > 0 => Loop though the |
| | orderBooks array, popping the next Order from |
| | each orderBook, removing Order.quantity from |
| | sellQuantity and adding it to the pertinent |
| | exchangeDeposit.sellQuantity. Also multiply |
| | Order.quantity * fee and add to |
| | exchangeDeposit.total.Fee. |
| iii. | Save each deposit to DB |
| iv. | Push each exchangeDeposit into Deposits array |
| v. | Return Deposits |

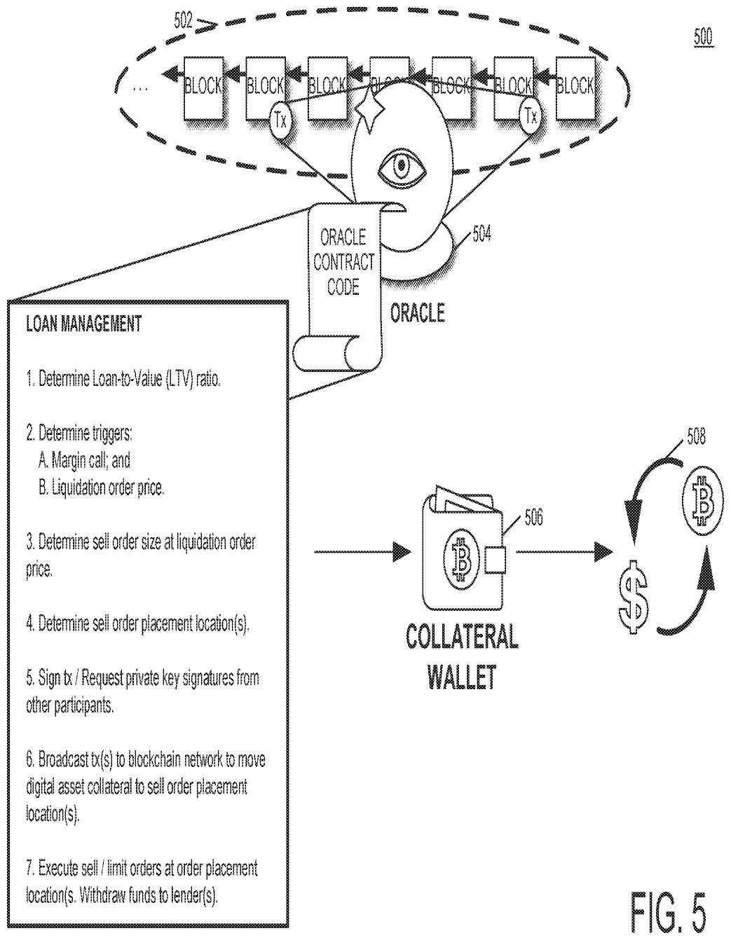

FIG. 5 is a diagram of an example system 500 with a blockchain oracle 504 performing loan monitoring operations and wallet operations on a wallet 506 containing digital asset collateral. One type of on-chain code of the oracle 504 (e.g., smart contract code) is for managing transactions from the collateral wallet 506 in the case that collateralization requirements of the loan agreement between the borrower and lender are not met. The oracle 504 contract code may perform functions that involve comparing loan agreement terms to data obtain from other sources (e.g., off-chain contact by the oracle 504, receiving status transactions on the blockchain 502 that include data, etc.) to determine whether collateralization requirements are met. The oracle 504 may also determine whether digital asset collateral in the wallet 506 satisfies certain conditions that can trigger an action by the oracle 504.

One of the components of the oracle contract code determines a Loan-to-Value ratio (LTV). One way to determine an LTV is to receive a repayment status of the loan collateralized by the collateral wallet 506 including a remaining principal amount and compare the remaining principal amount to an equivalent value of the digital asset collateral on the wallet 506. An equivalent value of the digital asset collateral may include, for example, a value in US Dollars. The value in US Dollars is calculated with information received by the oracle 504 from digital asset exchanges (whether received directly or indirectly by the oracle). The amount of digital asset in the wallet 506 (e.g., number of coins, tokens, etc. held in the wallet 506) may be determined on-chain 502 if the oracle 504 is on the same chain as the wallet 506 or it may be determined via contact with another chain where the wallet 506 resides.

Another component of the oracle contract code determines margin call and liquidation order triggers. Loan agreement terms may include a margin call condition (e.g., an LTV above which the margin call is triggered). If the oracle 504 determines that a margin call condition has been satisfied, then the oracle 504 may take actions to carry out the margin call. In one implementation, satisfaction of a margin call condition triggers a warning communication to a participant in the loan system (e.g., a borrower, a loan officer, a lender, a bank, a party who has extended credit to the borrower, etc.). The warning communication may be an electronic communication including without limitation an email, an SMS message, a notification, etc. to the loan system participant. In some implementations, the oracle 504 initiates the communication through contact with an API providing the communications service. In other implementations, another participant (e.g., a loan manager) sends a status transaction to the blockchain 502 network to ping the oracle 504 into taking action in response to the margin call condition satisfaction.

The warning communication may include a stop loss price at which some or all of the digital assets in the wallet 506 will be liquidated if the margin call condition is not removed and a liquidation condition is satisfied. The warning communication may include instructions to the recipient (e.g., the borrower) for steps that would remove the margin call condition. For example, the warning communication may include an amount of additional digital asset capital that would need to be added to the collateral wallet 506 to lower the LTV to a point where the margin call condition would no longer be satisfied. If the borrower or another party makes a payment of digital asset capital to the wallet 506, then the oracle 504 may send another message notifying that the margin call condition has been removed.

The oracle contract may also determine whether the digital assets in the wallet 506 satisfy a liquidation condition. Satisfying a liquidation condition may include an LTV that is higher than the LTV that triggers the margin call condition. Upon satisfaction of a liquidation condition, the oracle 504 may take any of several actions relating to liquidation of the digital assets in the collateral wallet 506. One action is to determine a stop loss price at which the digital assets will be sold at a liquidation location. The stop loss price may be related to a liquidation sell order size. It may not be necessary for the oracle 504 to sell all of the digital assets in the wallet 506. Instead, only a fraction of the digital assets may be sold to lower an LTV of the loan until the liquidation condition is no longer satisfied.

Another action taken by the oracle in response to the satisfaction of a liquidation condition is to determine sell order placement for the fraction of the digital assets in the wallet 506 to be liquidated. A determination of sell order placement may depend on various factors that affect the profitability to liquidation sales. Different liquidation locations 508 (e.g., digital asset exchanges) may charge different trading fees depending on a number of factors. Different liquidation locations may have varying amounts of liquidity that will limit how many coins or tokens may be sold below a certain price. At liquidation locations 508 with thin liquidity, selling digital assets may move the price more than on liquidation locations 508 with larger liquidity. Other liquidation locations 508 may not offer liquidity information (e.g., over-the-counter trading locations, brokers of digital assets, etc.). For liquidation locations 508 that do not provide liquidity information a sell quote may be obtained including a sales price for a certain amount of the digital asset to be liquidated.

After the oracle 504 has determined liquidation placement locations for liquidating digital assets in the collateral wallet 506 the fraction of the funds to be liquidated must be moved from the collateral wallet 506 to the liquidation locations 508. To accomplish the transfer, a transaction is formed that complies with the format and consensus rules of the blockchain 502. If the collateral wallet 506 is multiple wallets each holding a different digital asset, then there may be a separate transaction for up to all of a basket of digital assets that make up the collateral wallet 508. In one implementation, the collateral wallet 506 is a multisig wallet, such as a 3-of-4 multisig. As such, one participant in the system may create the transaction and sign the transaction with one of the private keys, if the entity is in possession of the one of the private keys. After the transaction has been created (and potentially also signed), the transaction can be circulated to the other loan participants that hold at least three of the four private keys needed to unlock the collateral wallet 506. In one implementation, the oracle 504 creates and signs the transaction, and then transmits the transaction to the loan manager and the lender (and additionally the borrower).

Once at least three of the four holders of private keys for the collateral wallet 506 have signed one or more transactions, those transactions may be broadcast to the blockchain 502. When holders of private keys receive a transaction and a request to sign the transaction from another participant (e.g., the oracle requests signature on a transaction the oracle created and signed), the holder of the private key can identify what would be the destination of the funds if the transaction is accepted by the blockchain network 502. What the holders of the private keys may not know is what real-world entity owns the address into which the funds would be deposited. The private key holders may further receive additional information from the oracle 504 relating to the identify of the liquidation locations 508 and/or the liquidation strategy for placing sell orders after the funds have been deposited at the liquidation locations 508. The holders of the private keys may seek independent verification of the ownership of a payee address in a transaction requested to be signed by the oracle 504. For example, liquidation locations 508 may be requested to sign a message with a private key that corresponds to the payee public key to prove that the liquidation location 508 actually controls the payee address.

Another component of the oracle contract code receives a signed transaction by other loan network participants and broadcasts the transaction to the blockchain 502. If the transaction is accepted by the blockchain 502, then funds will be moved out of the collateral wallet 506 to the one or more liquidation locations 508 according to the transaction. Other loan network participants may also broadcast the transaction to the blockchain network 502 as long as the transaction has been signed by at least the minimum number of private key holders to unlock the collateral wallet 506.

After funds have been successfully moved out of the collateral wallet 506 and onto the liquidation locations 508, the oracle contract code can submit sell orders at the liquidation locations 508 to convert the deposited digital assets into another currency. In some implementations, deposited digital assets are converted into the currency of the collateralized loan for application to the principal of a loan to reduce an LTV of the loan. The oracle 504 may submit limit sell orders on the deposited digital assets in accordance with the sell order placement determined when the LTV satisfied the liquidation condition. The oracle may then submit a withdraw order at the liquidation locations 508 to withdraw the purchased currency (e.g., a bank wire withdrawal of U.S. Dollars to a bank account controlled by a lender).

In one implementation, the following pseudo-code describes a non-limiting example of an algorithm for performing the oracle loan management services described herein including determining LTV, determining triggers for margin call and/or liquidation, placing margin warnings, signing a transaction and requesting signature from other participants:

| 1. | Calculate currentLTV = Loan.loanBalance / (Loan.collateralBalance * Price) | |
|---|---|---|
| 2. | Compare against LTV thresholds for Loan Product (still don't know where these are | |
| | stored) | |
| | a. | If (marginLTV < LTV < orderLTV) |

| | |
|---|---|
| i. | Execute Notifier(Lender, Message) |

| | |
|---|---|
| 1. | Message = General heads up about price movement. No action |
| | needed. |

| | |
|---|---|
| ii. | Execute Notifier(Borrower, Message) |

| | |
|---|---|
| 1. | Message = Options to make deposit (fiat or crypto) or do nothing. |

| | |
|---|---|
| iii. | Execute Trigger Calculator(Loan, Price, order LTV) |

| | |
|---|---|
| b. | If (orderLTV < LTV < liquidationLTV) |

| | |
|---|---|
| i. | If (first time) (no prior Transaction exists) |

| | |
|---|---|
| 1. | Execute Orderbook Analyzer(Loan, baseLTV, liquidationLTV) => |
| | returns Deposits |
| 2. | Execute Transaction Generator(Loan, Deposits) => returns |
| | Transaction |
| 3. | If (signature needed) |

| | |
|---|---|
| a. | Notifier(Lender, Message) |

| | |
|---|---|
| i. | Message = Signature needed for transaction. Price |
| | dropping, potential liquidation coming. |

| | |
|---|---|
| b. | Notifier(Borrower, Message) |

| | |
|---|---|
| i. | Message = Things are getting worse. Reminder to |
| | make deposit to avoid liquidation. Signature |
| | requested if you prefer to liquidate. |

| | |
|---|---|
| 4. | If (no signature needed - because manager has Lender's key) |

| | |
|---|---|
| a. | Notifier(Lender, Message) |

| | |
|---|---|
| i. | Message = Price dropping, potential liquidation |
| | coming. No action required. |

| | |
|---|---|
| b. | Notifier(Borrower, Message) |

| | |
|---|---|
| i. | Message = Things are getting worse. Reminder to |
| | make deposit to avoid liquidation. |

| | |
|---|---|
| ii. | If repeat (Transaction already exists) |

| | |
|---|---|
| 1. | If (Transaction already signed) |

| | |
|---|---|
| a. | Notifier(Borrower, Message) |

| | |
|---|---|
| i. | Message = Things are getting very worse. Last |
| | reminder to make deposit to avoid liquidation. |

| | |
|---|---|
| 2. | If (Transaction not signed) |

| | |
|---|---|
| a. | Notifier(Lender, Message) |

| | |
|---|---|
| i. | Message = Liquidation imminent − reminder to sign |
| | transaction. |

| | |
|---|---|
| b. | Notifier(Borrower, Message) |

| | |
|---|---|
| i. | Message = Things are getting very worse. Last |
| | reminder to make deposit to avoid liquidation. |
| | Signature requested if you prefer to liquidate. |

| | |
|---|---|
| iii. | Execute Trigger Calculator(Loan, Price, liquidationLTV) |

| | |
|---|---|
| c. | If (liquidationLTV < LTV) |

| | |
|---|---|
| i. | If (Transaction signed) |

| | |
|---|---|
| 1. | Execute Auditor, even though it should already be running. |

| | |
|---|---|
| ii. | If (Transaction not signed) |

| | |
|---|---|
| 1. | Notifier(Lender, Message) |

| | |
|---|---|
| a. | Message = Liquidation threshold breached, no sale occurred. |
| | Please sign transaction asap. |

| | |
|---|---|
| 2. | Notifier(Borrower, Message) |

| | |
|---|---|
| a. | Message = Liquidation threshold breached, no sale occurred. |
| | Reminder to make deposit or sign transaction. |

| | |
|---|---|
| iii. | Execute Trigger Calculator (Loan, Price, (liquidationLTV + .02)) |

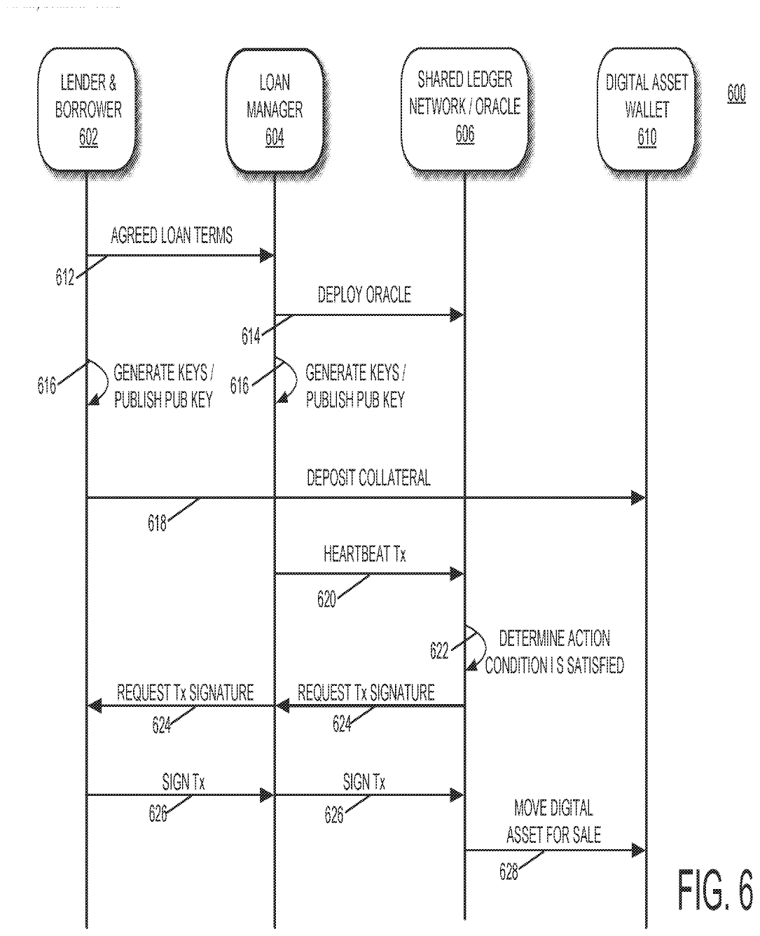

FIG. 6 is a signal diagram of an example system 600 with a blockchain oracle 606 performing loan monitoring operations and wallet operations on a digital asset wallet 610 containing digital asset collateral. At operation 612, a lender and borrower 602 send agreed loan terms to a loan manager 604. In one implementation, a loan manager 604 deploys the oracle 606 in a deploying operation 614. The deploying operation 614 may include an initialization transactions that established the oracle 606 on a blockchain. The initialization transaction may include information relevant to the management of the digital asset wallet 610 (e.g., the identities of the various participants in the loan network, payment addresses for participants including digital asset payment addresses and/or fiat currency bank account addresses, loan terms, loan schedule, permissions to monitor loan origination and/or repayments over the course of the loan, etc.). In other implementations, the loan manager at operation 614 determines an existing oracle for managing the loan agreed to between the lender and borrower. If the blockchain oracle 606 includes one or more smart contracts, the smart contracts may be recyclable (e.g., reusing a smart contract for a completed loan rather than destructing the contract and initializing a new contract). The smart contracts of the blockchain oracle 606 may also handle management of more than one active loan at the same time.

At operation 616, participants generate public/private key pairs. Optionally, operation 616 publishes a public key for other loan network participants to read. Alternatively, or additionally, operation 616 includes transmitting the public key to other loan network participants directly or indirectly. In a depositing operation 618, the borrower 602 deposits digital asset(s) into the digital asset wallet 610. The depositing operation may include a single or multiple transactions broadcast to a blockchain network. The payee of the single of multiple transactions of the depositing operation 618 may be determined from the output of the generating operation 616 based on a combination of the public keys generated therein. In some implementations, the loan manager 604 sends a heartbeat transaction 620 to the oracle 606, to “wake up” the oracle to perform other operations described herein. The heartbeat transaction 620 may include information for the oracle 606 that was collected from external sources (digital asset price feeds, liquidity levels at liquidation locations, loan status, etc.).

A determining operation 622 at the oracle 606 determines that an action condition is satisfied. The action condition may be based on an LTV of a loan as calculated by collecting information external to the system (e.g., loan status information, digital asset prices, etc.). Actions conditions include without limitation: adjustment of a minimum LTV, margin warning to the lender, liquidation action, updating of an internal state of the blockchain oracle 606 to reflect loan payments, interest charges, changes to the terms of the loan, changes to liquidity and/or price conditions of the digital asset collateral, etc.

Depending on the type of action condition satisfied at operation 622, the blockchain oracle 606 may conduct wallet operations on the digital asset collateral wallet 608. If wallet operations require more than one digital signature, such as in the case of a multisig collateral wallet, a requesting operation from the oracle 606 requests signatures by the private keys held by the loan manager 604, the lender and the borrower 602, and/or other participants needed to move digital assets from the collateral wallet 608. When the oracle 606 has a transaction signed by at least the minimum number of holders of a private key to unlock the digital asset wallet 610, a moving operation 628 broadcasts the signed transaction to a blockchain network to move the digital assets to liquidation locations for sale. The moving operation 628 may also include placing sell orders and transferring currency and/or digital assets out of the liquidation locations (e.g., wire transfer of U.S. Dollars to a lender).

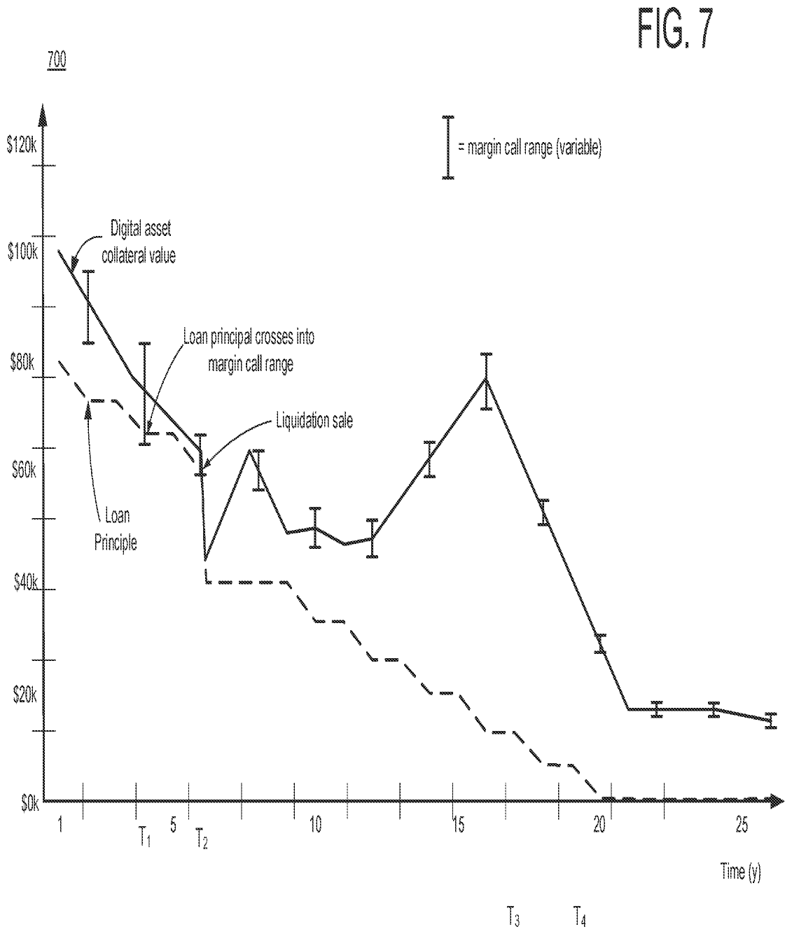

FIG. 7 is a plot 700 of outstanding loan balance and digital asset collateral value against time for a loan collateralized by a digital asset and managed by a blockchain oracle including a liquidation of collateral. Plot 700 illustrates a loan principle level shown by the dashed line and a digital asset collateral level shown by the solid line.

The digital asset collateral line includes periodic margin call range brackets. The margin call range brackets may be fixed (e.g., according to the loan agreement) or variable based on aspects of the digital asset (e.g., volatility, liquidity, etc.). If the loan principal level comes within the margin call range of the digital asset level, then a margin call is triggered. The margin call may include a warning to the buyer of imminent risk of liquidation of the digital asset. In the plot 700, the loan principal level declines in a stepwise manner until around time T₁, when the loan principal level crosses into the margin call range. When the loan principal is within the margin call range, a margin call condition is satisfied. In some implementations, the margin call condition is a trigger for a blockchain oracle to take actions including sending a margin call warning to participants in the loan system. A borrower or another party may at this time add more digital asset collateral to a digital wallet to reduce the LTV and avoid a liquidation condition.

In the example of plot 700, the loan principal level remains within the margin call range until time T₂, at which point a liquidation sale is triggered. Liquidation sales may be triggered in a variety of manners, depending on the terms of the loan agreement. In the example of plot 700, the loan principal level remains within the margin call range for a period of time, which triggers the oracle to initiate a liquidation sale (e.g., a liquidation condition is satisfied). When a liquidation condition is satisfied, the oracle may take several actions, including choosing liquidation locations, requesting cryptographic signatures on a transaction, broadcasting the transaction to the blockchain network to transfer funds to one or more liquidation locations, and place sell orders at those locations. In other implementations, a liquidation range may be calculated that is different then (e.g., broader than) the margin call range. Around time T₂, the liquidation sale reduces the amount of digital asset collateral and applies proceeds of the liquidation sale to the principle of the loan, both of which drop sharply around time T₂.

After time T₂, the loan principal continues to decrease in a stepwise fashion due to the borrower's periodic loan repayments. The digital asset collateral level increases (e.g., due to an increase in the exchange rate of the underlying digital asset) such that the loan principle level never crosses into the margin call range over the remainder of the course of the loan.

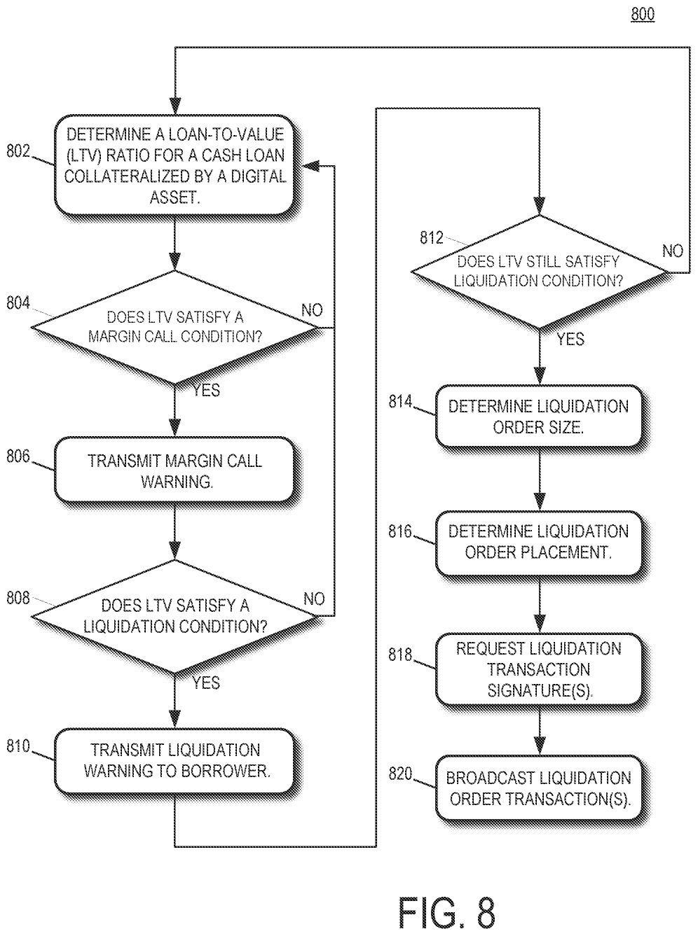

FIG. 8 illustrates example operations 800 for monitoring a loan and performing wallet operations on a digital asset collateral wallet by a blockchain oracle. A determining operation 802 determines a Loan-to-Value ratio (LTV) for a loan collateralized by a digital asset. The determining operation 802 may be performed by a blockchain oracle based on information obtained by or received by the oracle pertaining to a digital asset collateral wallet, a digital asset price, the status of a loan, etc. Alternatively, or additionally, the operation 802 may be determined by a lender, loan manager, or other participant in the system.

The operations 800 return to determining operation 802 if the LTV does not satisfy a margin call condition and proceed to a transmitting operation 806 if the LTV does satisfy a margin call condition. The transmitting operation 806 may transmit a margin call warning to loan network participants informing them of impending danger of liquidation. The margin call warning may include instructions on removing the margin call condition (e.g., adding more capital to the collateral wallet). At 808, the operations 800 return to determining operation 802 if the LTV does not satisfy a liquidation condition and proceed to transmitting operation 810 if the LTV does satisfy the liquidation condition. If the LTV still satisfies the liquidation condition at 812, the operations 800 continue to determining operation 814.

Determining operation 814 determines a liquidation order size. In other words, determining operation 814 determines how many units of the digital asset collateral should be sold to remove the liquidation condition. In some implementations, a liquidation will reduce the LTV to just below the liquidation condition level. In other implementations, a liquidation will reduce the LTV by a predetermined amount below the liquidation condition, limited by the amount of available capital in the collateral wallet. A determining operation 816 determines liquidation order placement. The determining operation 816 may include a liquidation level determination at more than one liquidation location to apportion a fraction of the sell order determined in determining operation 814 to each of the liquidation locations. The determining operation 816 may include a blockchain oracle obtaining liquidity and other information pertaining to the liquidation locations from off-chain sources.

A requesting operation 818 requests liquidation transaction signatures from other loan network participants who hold private keys for the digital asset wallet. A broadcasting operation 820 broadcasts the signed transaction to the blockchain network to move digital assets for liquidation.

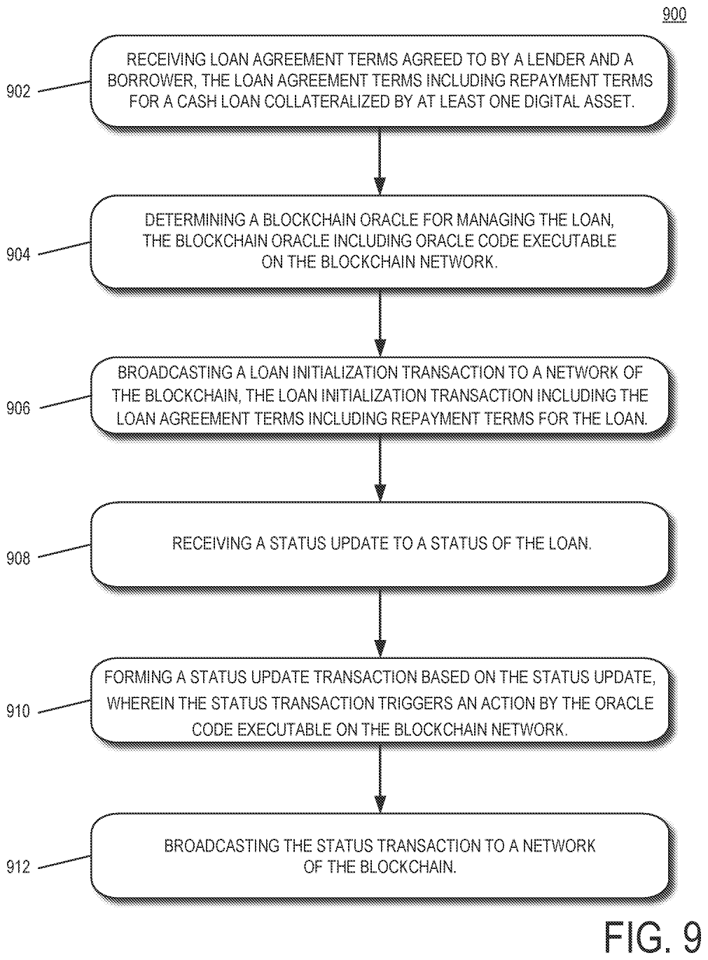

FIG. 9 illustrates example operations 900 for managing a digital asset collateral wallet. A receiving operation 902 receives loan agreement terms agreed to by a lender and a borrower including repayment terms for a loan collateralized by at least one digital asset. A determining operation 904 determines a blockchain oracle for managing the loan, the blockchain oracle including oracle code executable on the blockchain network. The determining operation 904 may include an initialization transaction to deploy a new blockchain oracle for managing the loan agreement received in operation 902. In other implementations, the determining operation 904 may include determining an existing blockchain oracle may manage the loan agreement received in operation 902.

A broadcasting operation 906 broadcasts a loan initialization transaction to a network of the blockchain, the loan initialization transaction including the loan agreement terms including loan repayment terms for the loan. A receiving operation 908 receives one or more updates to a status of the loan. In one implementation, a loan manager receives the updates to the status of the loan from a lender, borrower, bank, or other entity with access to the information.

A forming operation 910 forms a status update transaction based on the status update, wherein the status transaction triggers an action by the oracle code executable on the blockchain network. The status update transaction may be viewed as a “ping” or “heartbeat” transaction to the blockchain oracle and may cause the oracle to update its internal state and/or perform wallet operations on the digital asset collateral wallet. A broadcasting operation 912 broadcasts the status transaction to a network of the blockchain for confirmation according to the consensus rules.

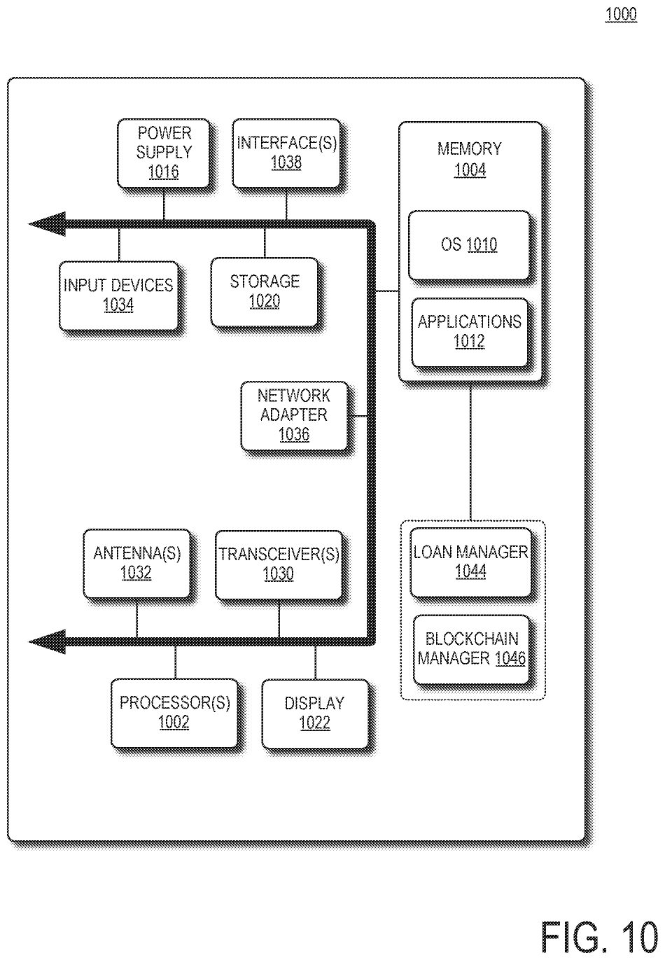

FIG. 10 illustrates an example system 1000 that may be helpful in using the digital asset collateral wallet. FIG. 10 illustrates an example system (labeled as a processing system 1000) that may be useful in implementing the described technology. The processing system 1000 may be a client device, such as a smart device, connected device, Internet of Things (IoT) device, laptop, mobile device, desktop, tablet, or a server/cloud device. The processing system 1000 includes one or more processor(s) 1002, and a memory 1004. The memory 1004 generally includes both volatile memory (e.g., RAM) and non-volatile memory (e.g., flash memory). An operating system 1010 resides in the memory 1004 and is executed by the processor 1002.

One or more application programs 1012 modules or segments, such as loan manager 1044 and blockchain manager 1046 are loaded in the memory 1004 and/or storage 1020 and executed by the processor 1002. In some implementations, the trusted execution environment 1044 is stored in read only memory (ROM) 1014 or write once, read many (WORM) memory. Data such as loan terms may be stored in the memory 1004 or storage 1020 and may be retrievable by the processor 1002 for use by loan manager 1044 and the blockchain manager 1046, etc. The storage 1020 may be local to the processing system 1000 or may be remote and communicatively connected to the processing system 1000 and may include another server. The storage 1020 may store resources that are requestable by client devices (not shown). The storage 1020 may include secure storage such as one or more platform configuration registers (PCR) manages by one or more trusted platform modules (TPMs), which may be implanted in a chip or by the trusted execution environment TEE.

The processing system 1000 includes a power supply 1016, which is powered by one or more batteries or other power sources and which provides power to other components of the processing system 1000. The power supply 1016 may also be connected to an external power source that overrides or recharges the built-in batteries or other power sources.

The processing system 1000 may include one or more communication transceivers 1030 which may be connected to one or more antenna(s) 1032 to provide network connectivity (e.g., mobile phone network, Wi-Fi®, Bluetooth®, etc.) to one or more other servers and/or client devices (e.g., mobile devices, desktop computers, or laptop computers). The processing system 1000 may further include a network adapter 1036, which is a type of communication device. The processing system 1000 may use the network adapter 1036 and any other types of communication devices for establishing connections over a wide-area network (WAN) or local-area network (LAN). It should be appreciated that the network connections shown are exemplary and that other communications devices and means for establishing a communications link between the processing system 1000 and other devices may be used.

The processing system 1000 may include one or more input devices 1034 such that a user may enter commands and information (e.g., a keyboard or mouse). Input devices 1034 may further include other types of input such as multimodal input, speech input, graffiti input, motion detection, facial recognition, physical fingerprinting, etc. These and other input devices may be coupled to the server by one or more interfaces 1038 such as a serial port interface, parallel port, universal serial bus (USB), etc. The processing system 1000 may further include a display 1022 such as a touch screen display.

The processing system 1000 may include a variety of tangible processor-readable storage media and intangible processor-readable communication signals including in virtual and/or cloud computing environment. Tangible processor-readable storage can be embodied by any available media that can be accessed by the processing system 1000 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing system 1000. In contrast to tangible processor-readable storage media, intangible processor-readable communication signals may embody computer-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

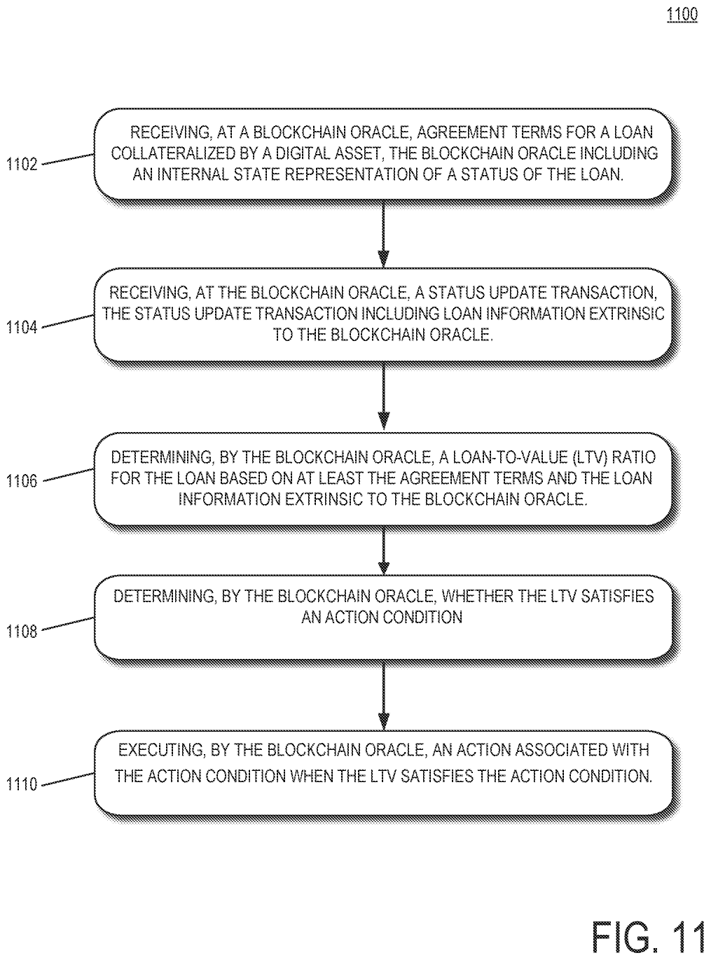

FIG. 11 illustrates example operations 1100 for a blockchain oracle managing a loan collateralized by a digital asset. A receiving operation 1102 receives, at a blockchain oracle, agreement terms for a loan collateralized by a digital asset, the blockchain oracle including an internal state representation of a status of the loan. The internal state representation may include parameters used to test whether a loan satisfies an action condition. For example, at a time of origination, a lender may agree to a minimum LTV ratio for the loan. As the loan progresses through time and the borrower makes regular payments thereon, the LTV ratio will change, possibly allowing the borrower to withdraw part of the digital asset funds held in the collateral wallet. The internal state representation of the loan may be updated to reflect a current LTV as the balance of the loan declines. Observers of the blockchain on which the blockchain oracle executes (e.g., a public ledger) can view the internal state representation of the loan to determine whether a proposed action is in accordance with the loan agreement terms. Other aspects of the loan can be handled by the internal state representation (e.g., if the borrower changes its contact information, if the loan is sold and a new entity is now the lender, etc.).

A receiving operation 1104 receives a status update transaction including loan information extrinsic to the blockchain oracle (e.g., off-chain data not available to the blockchain oracle strictly from reading the chain itself). For example, the status transaction can include a request from a borrower to withdraw a portion of the collateral. In another example, a lender may modify the minimum LTV that it will accept on the loan due to changes in extrinsic conditions such as a reduction in available liquidity of the digital asset collateral held in the collateral wallet (e.g., it would be harder to liquidate the collateral to return the LTV to an acceptable level in a low-liquidity environment and the blockchain oracle may not be able to liquidate fast enough or at a price high enough to cover the lender's potential loss on the loan if the borrower goes into default). Other examples of the loan information extrinsic to the blockchain include price of the digital asset, repayment history, etc.

A determining operation 1106 determines, by the blockchain oracle, a loan-to-value (LTV) ratio for the loan based on at least the agreement terms and the loan information extrinsic to the blockchain oracle. As status updates come in to the blockchain oracle, the LTV should fluctuate based on changing digital asset value and repayment history. Another determining operation 1108 determines, by the blockchain oracle, whether the LTV satisfies an action condition. In implementations, action conditions are included in the loan agreement terms governing when an LTV triggers actions (e.g., margin warning, offer to withdraw/add collateral, margin call, change in minimum LTV level). Each action condition can be triggered at a different LTV ratio, depending on the parameters of the loan agreement.

An executing operation 1110 executes, by the blockchain oracle, an action associated with the action condition when it is satisfied by the LTV. In many cases, the blockchain oracle may not be equipped to carry out the action itself (e.g., warning a borrower of an impending margin call). In these cases, the blockchain oracle can record the existence of the action condition to the blockchain to yield an action request that can be acted upon by another participant. For example, if the action condition is a margin call warning, recording the margin call warning to the chain as a request to transmit the margin call to a borrower can cause another party monitoring the chain to send a margin call warning to the borrower.

In some implementations, the blockchain oracle may include smart contract logic to determine whether its internal state representation has become invalid. An example of invalidity may include staleness of the internal representation such as when the blockchain oracle has not received a status transaction over an elapsed period of time. Staleness could cause a future status update (e.g., a request to withdraw collateral) to reach an incorrect determination if the real status of the loan has changed without updating the blockchain oracle internal status representation. In such as case, the blockchain oracle can lock down until it receives fresh extrinsic information regarding the loan. In another example, a status transaction can include extrinsic data that fails a validity check (e.g., price and/or liquidity values are determined to be out of bounds with reference to an expected range).

In one implementation is disclosed a method of managing a digital asset collateral wallet including receiving loan agreement terms agreed to by a lender and a borrower, the loan agreement terms including repayment terms for a loan collateralized by a digital asset, determining a blockchain oracle for managing the loan, the blockchain oracle including oracle code executable on the blockchain network, broadcasting a loan initialization transaction to a network of the blockchain, the loan initialization transaction including the loan agreement terms including repayment terms for the loan collateralized by the digital asset, receiving a status update to a status of the loan, forming a status update transaction based on the status update, the status transaction satisfying the consensus rules of the blockchain network, wherein the status transaction triggers an action by the oracle code executable on the blockchain network, and broadcasting the status transaction to a network of the blockchain.

An implementation of any previous implementation may further include wherein the status update includes an update to a history of repayment installments from the borrower to the lender.

An implementation of any previous implementation may further include wherein the status update includes a market price of the at least one digital asset.

An implementation of any previous implementation may further include wherein the status update includes a liquidity value of the at least one digital asset.

An implementation of any previous implementation may further include wherein the action triggered by the status transaction includes writing at least a portion of the status update to a shared ledger of the blockchain network.

An implementation of any previous implementation may further include receiving one or more public keys, and generating a multisignature address of a digital asset collateral wallet based at least in part on the one or more public keys.

In another implementation is disclosed a system for managing a loan collateralized by a digital asset via a blockchain oracle including a blockchain oracle deployer configured to broadcast a blockchain oracle initialization transaction to a blockchain network, the blockchain oracle initialization transaction including agreement terms between a lender and a borrower for a loan collateralized by the digital asset and further including oracle code executable on the blockchain network, and a blockchain oracle updater configured to transmit an update transaction to the blockchain oracle, the update transaction triggering an action by the oracle code executable on the blockchain network when the update transaction is confirmed by the blockchain network.

An implementation of any previous implementation may further include wherein the update transaction includes a current status of the loan, the blockchain oracle updating an internal loan configuration based on the current status.

An implementation of any previous implementation may further include wherein the update transaction includes an update to loan-to-value collateral rules applied by the blockchain oracle.

An implementation of any previous implementation may further include wherein the update transaction includes a liquidity value of the digital asset.

An implementation of any previous implementation may further include wherein the digital asset collateral wallet key generator is further configured to transmit the multisignature public key to a borrower device.

An implementation of any previous implementation may further include wherein the blockchain oracle constructs a liquidation transaction if a liquidation condition has been satisfied.

Another implementation is disclosed with a method of managing a loan with digital asset collateral receiving, at a blockchain oracle, agreement terms for a loan collateralized by a digital asset, the blockchain oracle including an internal state representation of a status of the loan, receiving, at the blockchain oracle, a status update transaction, the status update transaction including loan information extrinsic to the blockchain oracle, determining, by the blockchain oracle, a loan-to-value ratio (LTV) for the loan based on at least the agreement terms and the loan information extrinsic to the blockchain oracle, determining, by the blockchain oracle, whether the LTV satisfies an action condition, and executing, by the blockchain oracle, the action when the LTV satisfies the action condition.

An implementation of any previous implementation may further include recording the action condition to a blockchain of the blockchain oracle to yield an action request, the action request being readable by an observer of the blockchain.

An implementation of any previous implementation may further include wherein the action condition is a margin call warning condition and the action request is a request to transmit a margin call warning to a borrower.

An implementation of any previous implementation may further include determining, at the blockchain oracle, that the internal state representation of the status of the loan is invalid, and recording an invalidity flag to a blockchain of the blockchain oracle.

An implementation of any previous implementation may further include wherein the invalidity flag is a staleness flag.

An implementation of any previous implementation may further include wherein the invalidity flag is based on a validation of the status update including loan information extrinsic to the blockchain oracle.

An implementation of any previous implementation may further include wherein loan information extrinsic to the blockchain oracle includes a liquidity of the digital asset and the status update transaction modifies the agreement terms to raise a minimum LTV ratio of the loan.

An implementation of any previous implementation may further include wherein the action request is a request for one or more participants to sign a liquidation transaction moving funds from a digital asset collateral wallet

Of course, the applications and benefits of the systems, methods and techniques described herein are not limited to only the above examples. Many other applications and benefits are possible by using the systems, methods and techniques described herein. Any feature described in one example herein can be combinable with any other feature of the same example or of a different example transaction.

Furthermore, when implemented, any of the methods and techniques described herein or portions thereof may be performed by executing software stored in one or more non-transitory, tangible, computer readable storage media or memories such as magnetic disks, laser disks, optical discs, semiconductor memories, biological memories, other memory devices, or other storage media, in a RAM or ROM of a computer or processor, etc.

1-20. (canceled)

21. A system for autonomously managing a loan collateralized by a digital asset via a blockchain oracle that is deployed on a blockchain, the system comprising:
a processor;
a computer network interface; and
a memory storing instructions that, when executed by the processor, are configured to cause the system to:
broadcast an initialization transaction to at least one peer on a network of the blockchain via the computer network interface, the initialization transaction comprising blockchain oracle code for establishing the blockchain oracle, wherein the initialization transaction includes agreement terms between a lender and a borrower for the loan collateralized by the digital asset;
transmit a heartbeat transaction to the at least one peer on the network of the blockchain via the computer network interface, wherein the heartbeat transaction includes a digital asset price feed, and wherein in response to the heartbeat transaction the blockchain oracle is configured to:
(a) wake up upon confirmation of the heartbeat transaction to the blockchain;
(b) determine a loan-to-value (LTV) ratio for the loan collateralized by the digital asset based on the market price of the digital asset included in the heartbeat transaction and the agreement terms between the lender and the borrower included in the initialization transaction;
(c) determine whether the LTV ratio satisfies a margin call condition that is specified in the agreement terms; and
(d) transmit a margin call warning that includes an instruction to remove the margin call condition to the borrower in response to a determination that the LTV ratio does satisfy the margin call condition.

22. The system of claim 1, wherein the heartbeat transaction includes a current status of the loan collateralized by the digital asset, the blockchain oracle updating an internal loan configuration based on the current status.

23. The system of claim 1, wherein the heartbeat transaction includes an update to loan-to-value collateral rules applied by the blockchain oracle.

24. The system of claim 1, wherein the heartbeat transaction includes a liquidity value of the digital asset.

25. The system of claim 1, wherein the heartbeat transaction, upon confirmation to the blockchain, further prompts the blockchain oracle to:
(d1) determine whether the LTV ratio satisfies a liquidation condition;
in response to a determination that the LTV ratio does satisfy the liquidation condition:
(d2) determine a liquidation order size;
(d3) determine one or more liquidation order placement locations, by receiving order books including bids for the digital asset from each of a plurality of potential liquidation locations, each bid having a quantity associated therewith, sorting the bids from low to high, looping through the bids and adding each bid quantity to its respective liquidation location until an entire quantity of the digital asset collateral has been assigned to a liquidation location;
(d4) for each liquidation location, request one or more liquidation transaction signatures for liquidation order transaction in an amount equal to a fraction of the digital asset collateral assigned in step (d3) to the respective liquidation location; and
(d5) broadcast the one or more liquidation order transactions of step (d4) to the at least one peer on the network of the blockchain.

26. The system of claim 21, wherein the margin call warning specifies an amount of additional digital asset capital that is needed to lower the LTV ratio to a point where the margin call condition would no longer be satisfied.

27. The system of claim 22, wherein the blockchain oracle is further configured to:
determine that the current status of the loan is invalid; and
record an invalidity flag to a blockchain of the blockchain oracle.

28. The system of claim 27, wherein the invalidity flag is a staleness flag.

29. The system of claim 27, wherein the invalidity flag is based on a validation of the heartbeat transaction including loan information extrinsic to the blockchain oracle.

30. The system of claim 21, wherein transmitting the margin call warning comprises recording the margin call warning directly to the blockchain and not transmitting the margin call warning via the computer network interface.

31. A system for autonomously managing a loan collateralized by a digital asset, the system comprising:
a processor;
a computer network interface; and
a memory storing instructions that, when executed by the processor, are configured to cause the system to:
receive an initialization transaction from at least one peer on a network of the blockchain via the computer network interface, the initialization transaction comprising blockchain oracle code, wherein the initialization transaction includes agreement terms between a lender and a borrower for the loan collateralized by the digital asset;
establish a blockchain oracle in response to receiving the initialization transaction;
receive a heartbeat transaction from the at least one peer on the network of the blockchain via the computer network interface, wherein the heartbeat transaction includes a digital asset price feed;
in response to the heartbeat transaction being confirmed on the blockchain:
(a) wake up upon confirmation of the heartbeat transaction to the blockchain;
(b) determine a loan-to-value (LTV) ratio for the loan collateralized by the digital asset based on the digital asset price feed of the digital asset included in the heartbeat transaction and the agreement terms between the lender and the borrower included in the initialization transaction;
(c) determine whether the LTV ratio satisfies a margin call condition that is specified in the agreement terms; and
(d) transmit a margin call warning that includes an instruction to remove the margin call condition to the borrower in response to a determination that the LTV ratio does satisfy the margin call condition.

32. The system of claim 31, wherein the heartbeat transaction includes a current status of the loan collateralized by the digital asset, the blockchain oracle updating an internal loan configuration based on the current status.

33. The system of claim 31, wherein the heartbeat transaction includes an update to loan-to-value collateral rules applied by the blockchain oracle.

34. The system of claim 31, wherein the heartbeat transaction includes a liquidity value of the digital asset.

35. The system of claim 31, wherein the system is further configured, upon confirmation of the heartbeat transaction to the blockchain, to:
(d1) determine whether the LTV ratio satisfies a liquidation condition;
in response to a determination that the LTV ratio does satisfy the liquidation condition:
(d2) determine a liquidation order size;
(d3) determine one or more liquidation order placement locations, by receiving order books including bids for the digital asset from each of a plurality of potential liquidation locations, each bid having a quantity associated therewith, sorting the bids from low to high, looping through the bids and adding each bid quantity to its respective liquidation location until an entire quantity of the digital asset collateral has been assigned to a liquidation location;
(d4) for each liquidation location, request one or more liquidation transaction signatures for liquidation order transaction in an amount equal to a fraction of the digital asset collateral assigned in step (d3) to the respective liquidation location; and
(d5) broadcast the one or more liquidation order transactions of step (d4) to the at least one peer on the network of the blockchain.

36. The system of claim 31, wherein the margin call warning species an amount of additional digital asset capital that is needed to lower the LTV ratio to a point where the margin call condition would no longer be satisfied.

37. The system of claim 32, wherein the blockchain oracle is further configured to:
determine that the current status of the loan is invalid; and
record an invalidity flag to a blockchain of the blockchain oracle.

38. The method of claim 37, wherein the invalidity flag is a staleness flag.

39. The method of claim 37, wherein the invalidity flag is based on a validation of the heartbeat transaction including loan information extrinsic to the blockchain oracle.

40. The system of claim 31, wherein transmitting the margin call warning comprises recording the margin call warning directly to the blockchain and not transmitting the margin call warning via the computer network interface.
